(19) United States
(12) Patent Application Publication
(10) Pub. No.: US 2007/0161488 A1
(43) Pub. Date: Jul. 12, 2007

(54) Folding device having a stationary folding knife

(76) Inventors: Claus-Dieter Redmer, Oppenweiler (DE); Eberhard Krieger, Strumpfelbach (DE); Hagen Wetzel, Oppenweiler (DE)

Correspondence Address: BACHMAN & LAPOINTE, P.C., 900 CHAPEL STREET, SUITE 1201, NEW HAVEN, CT, 06510, US

(21) Appl. No.: 11/643,367

(22) Filed: Dec. 20, 2006

(30) Foreign Application Priority Data
Dec. 27, 2005 (DE) 10 2005 062 843.5

(51) Int. Cl. B31F 1/10

(52) U.S. Cl. 493/444

(57) ABSTRACT

A folding device comprises a sheet transporting device (52) for transporting sheets (22) in a sheet support plane (BE) and a stationary folding knife (26) arranged opposite the sheet support plane (BE) in a sheet running direction (BL), the folding knife (26) comprising, at the side facing the sheet support plane (BE), folding edge means contacting a sheet (22) during the transport for forming a folding line in the sheet (22). In order to avoid a set-off of the printing color or the toner during the folding of sheets that are hot off the press or digitally printed, the folding edge means (28) comprises several folding rollers (30) being arranged one after the other in the sheet running direction (BL) and each being supported rotatably about a rotation axis (50) extending perpendicularly to the sheet running direction (BL).

### BACKGROUND OF THE INVENTION

The invention relates to a folding device comprising a sheet transporting device for transporting sheets in a sheet support plane and a stationary folding knife arranged opposite said sheet support plane in a sheet running direction, said folding knife comprising, at the side facing said sheet support plane, folding edge means contacting a sheet during the transport for forming a folding line in said sheet.

Such a known folding device is shown in FIGS. 1 and 2. The known folding device 1 comprises a sheet transporting device 12 (FIG. 2), by which sheets 2a, 2b are moved in a sheet running direction BL under a folding knife 5 extending in the sheet running direction, said folding knife 5 having a folding blade 3 at its side facing the sheet running plane BE, said folding blade 3 facing an upper strand 10 of a transport belt of the sheet transporting device 12, said transport belt extending in the sheet running direction BL. The distance between the lower end of the folding blade 3 and the upper strand 10 of the transport belt is adjusted such that a folding line extending in the sheet running direction is formed in the sheets 2a, 2b when the sheet is transported in the sheet running direction under the folding knife 5. For guiding the sheet 2a, 2b along the folding knife 5, transporting rollers 4 are provided at both sides of the folding knife, said transporting rollers 4 contacting the upper side of the sheet 2a, 2b.

After their passage through the folding knife 5 the sheets 2a, 2b are folded upwards about the formed folding line in a former folding means 6 having sheet-metal formers 8, 9, a pair of pressing rollers 7 being provided at the exit of the former folding means 6, through which pair of pressing rollers 7 the folding edge of a sheet 2c folded by the former folding means 6 is guided, in order to form the folding edge exactly.

If sheets that are hot off the press or digitally printed are fed to the folding device 1, a set-off of the printing color or the toner may occur during the forming of the folding line because the sheet slides along the folding blade 3.

The object underlying the invention is to create a folding device by means of a simple design which ensures that no set-off occurs during the forming of the folding line through the folding knife.

### SUMMARY OF THE INVENTION

According to the invention, this object is achieved by a folding device comprising a sheet transporting device for transporting sheets in a sheet support plane and a stationary folding knife arranged opposite said sheet support plane in a sheet running direction, said folding knife comprising, at the side facing said sheet support plane, folding edge means contacting a sheet during the transport for forming a folding line in said sheet, wherein said folding edge means comprises several folding rollers being arranged one after the other in said sheet running direction and each being supported rotatably about a rotation axis extending perpendicularly to said sheet running direction.

In the folding device according to the invention, the forming of the folding line in the sheet is done by rotatably supported folding rollers, which during the passage of the sheets under the folding knife rotate through the contact with the sheets, for which reason the circumferential speed of the folding rollers corresponds to the sheet running speed. This ensures that no set-off of the printing color or the toner occurs in sheets that are hot off the press or digitally printed.

Preferably, said sheet transporting device comprises a circulating transport belt, the upper strand of which is situated opposite said folding rollers. This ensures that the sheet is well supported in the area opposite the folding rollers, in order to enable a uniform folding line.

The guidance of the sheet may be improved if said sheet transporting device comprises transporting rollers arranged at both sides of said folding knife.

If digitally printed, folded sheets are to be collected one on top of the other subsequently to the folding device, this can only be done with an open fold. For this, it is suitable to arrange a former folding means behind said folding knife in said sheet running direction.

### BRIEF DESCRIPTION OF THE DRAWINGS

An exemplary embodiment of the invention will be explained in greater detail below with reference to drawings, in which:

FIG. 1 shows a schematic perspective view of a known folding device,

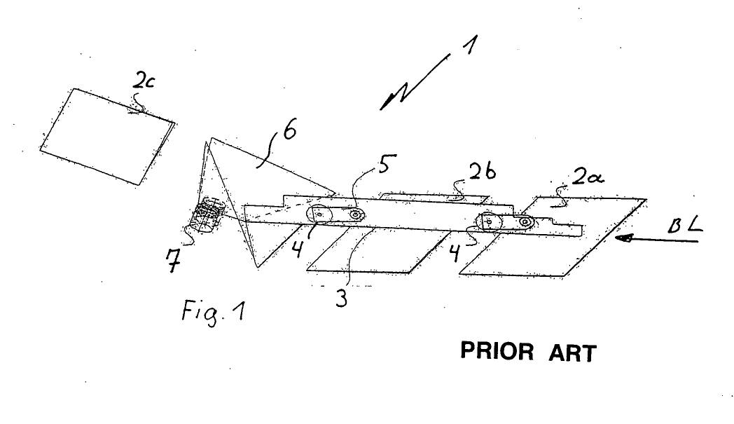

FIG. 2 shows a cross-sectional view of the folding device of FIG. 1 in the area of a folding knife;

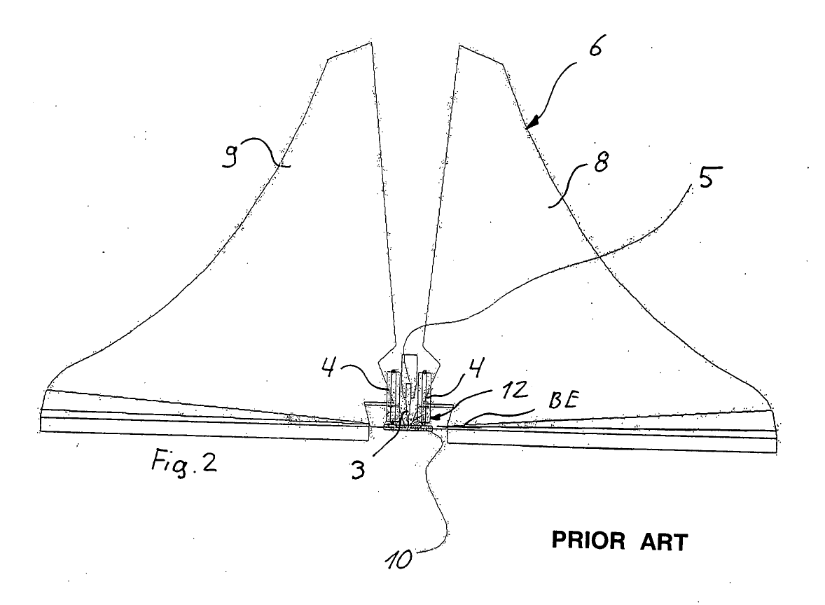

FIG. 3 shows a perspective view of a folding device according to the invention;

FIG. 4 shows a cross-sectional view of the folding device of FIG. 3 in the area of a folding knife;

FIG. 5 shows a cross-sectional view of the folding knife on a larger scale.

### DETAILED DESCRIPTION

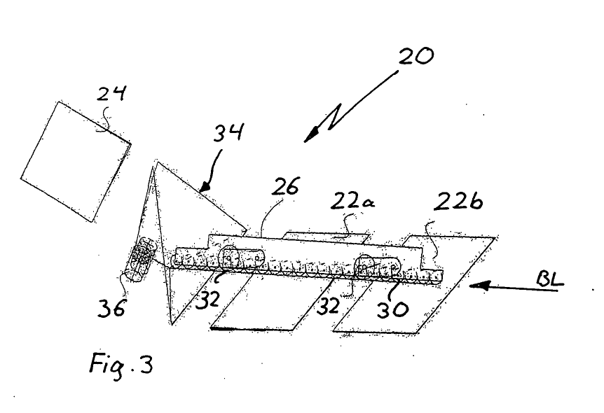

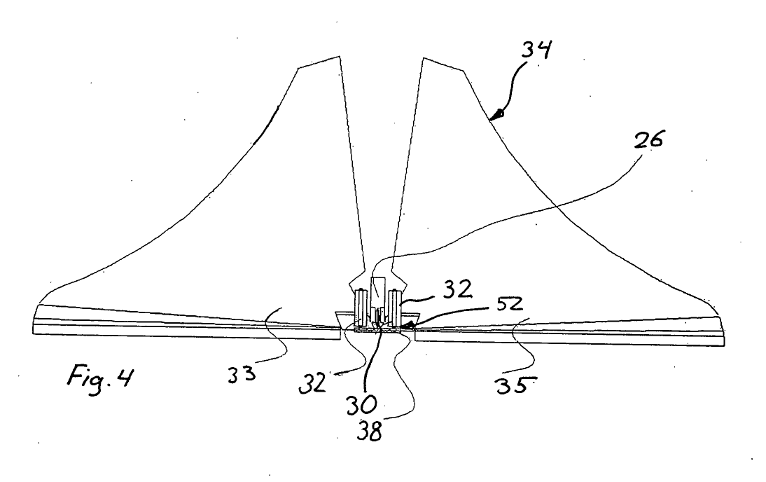

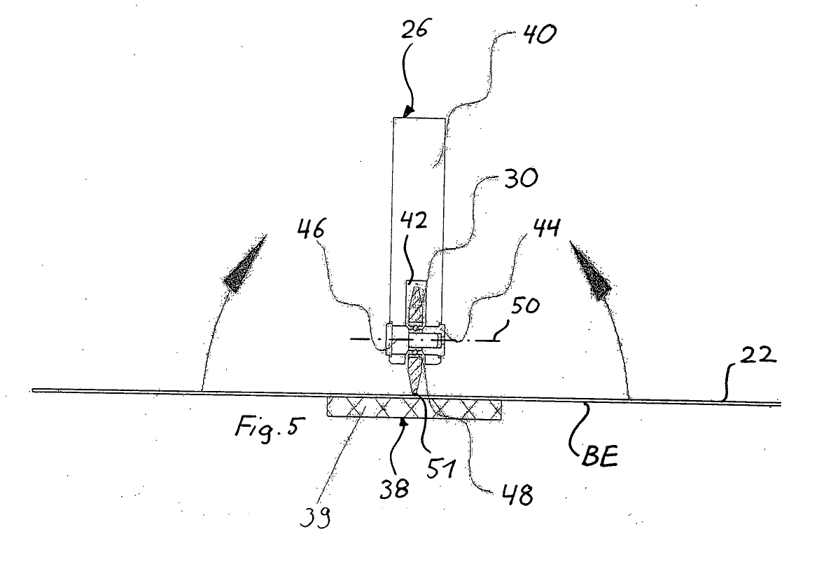

The folding device 20 shown in FIGS. 3 to 5 comprises a sheet transporting device 52 comprising at least one endless circulating transport belt 38, the upper strand 39 of which is shown in FIGS. 4 and 5. Above the upper strand 39 a folding knife 26 is arranged in the longitudinal direction of the transport belt 38, i.e. in a sheet running direction BL. The folding knife 26 comprises a knife strip 40 fixed as a mount and extending in parallel to the sheet running or support plane BE, in the lower edge of which a recess 42 being open downwards and having a rectangular cross section is formed. In the recess 42 a plurality of folding rollers 30 are accommodated, each of which is supported rotatably about a rotation axis 50 by means of a deep-groove ball bearing 48 on a bearing bolt 46 extending transversely through the knife strip 40 and the recess 42. The right end in FIG. 5 of the bearing bolt 46 is fixed by a bearing bush 44.

The cross section of the folding rollers 30 decreases towards their outer circumference and ends in an apex 51, the contour of which corresponds to the contour of the cross section of a desired folding line.

As can be seen from FIG. 3, a plurality of corresponding folding rollers 30 is arranged one after the other in the longitudinal direction of the folding knife 26. In addition, transporting rollers 32 for guiding a sheet 22 during a passage under the folding knife 26 are provided at both sides of the folding knife 26.

The end of the folding knife 26 situated downstream in the sheet running direction BL ends between two sheet-metal formers 33, 35 of a former folding means 34. A pair of pressing rollers 36 is arranged at the exit of the former folding means 34.

The folding device 20 according to the invention is especially suitable for folding sheets that are hot off the press or digitally printed, which subsequently to the folding device 20 are collected with open fold one on top of the other in a collecting means. The folding sheets 22a, 22b are guided by means of the sheet transporting device 52 in the sheet running direction BL under the folding knife 26. The distance between the outer circumference of the folding rollers 30 and the upper strand 39 of the transport belt 38 is dimensioned such that through the folding rollers 30 during the passage of the sheets 22a, 22b a folding line having a desired depth is formed by the apex 51 of the folding rollers 30 in the sheet 22a, 22b. The circumferential speed of the folding rollers 30 corresponds to the sheet running speed during the passage of the sheets 22a, 22b, so that there is no relative speed difference, which could lead to a set-off of a printing color or a toner on the sheet 22a, 22b.

As indicated by the two arrows in FIG. 5, due to the forming of the folding line both sides of the sheet 22 tend to move upwards relating to the folding knife 26. After leaving the folding knife 26 the sheets 22a, 22b enter between the sheet-metal formers 33, 35 of the former folding means 34 and are folded upwards about the folding line by them. By the pressing roller means 36 provided at the exit of the former folding means 34 a pressure is built up on the formed folding edge, whereby it is formed more exactly. The folding sheet 24 folded by the former folding means 34 is subsequently fed to a collecting means.

1. A folding device comprising a sheet transporting device for transporting sheets in a sheet support plane and a stationary folding knife arranged opposite said sheet support plane in a sheet running direction, said folding knife comprising, at a side facing said sheet support plane, folding edge means contacting a sheet during a transport for forming a folding line in said sheet, wherein said folding edge means comprises several folding rollers being arranged one after the other in said sheet running direction and each being supported rotatably about a rotation axis extending perpendicularly to said sheet running direction.

2. A device as claimed in claim 1, wherein said sheet transporting device comprises at least one circulating transport belt, an upper strand of which is situated opposite said folding rollers.

3. A device as claimed in claim 1, wherein said sheet transporting device comprises transporting rollers arranged at both sides of said folding knife.

4. A device as claimed in claim 1, wherein a former folding means is arranged behind said folding knife in said sheet running direction.
